(19) United States
(12) Patent Application Publication
(10) Pub. No.: US 2012/0327511 A1
(43) Pub. Date: Dec. 27, 2012

(54) OPTICAL FILM, METHOD OF PRODUCING OPTICAL FILM, POLARIZING PLATE, DISPLAY PANEL, AND DISPLAY

(75) Inventors: Shigeki Murakami, Tokyo-to (JP); Takanobu Tadaki, Kanagawa-ken (JP)

(73) Assignee: DAI NIPPON PRINTING CO., LTD., Tokyo-to (JP)

(21) Appl. No.: 13/517,112

(22) PCT Filed: Dec. 22, 2010
(86) PCT No.: PCT/JP2010/073178

§ 371 Date: Aug. 22, 2012

(30) Foreign Application Priority Data
Dec. 28, 2009 (JP) 2009-298797
Dec. 17, 2010 (JP) 2010-281788

(51) Int. Cl. G02B 5/30; B05D 5/06; B32B 33/00

(52) U.S. Cl. 359/483.01; 428/335; 427/164

(57) ABSTRACT

Disclosed is an optical film having hardness and wipe-off resistance to solvents and capable of maintaining antistatic performance for a long period, and a method of producing the same. The optical film includes an optically-transparent substrate, and a hard coat layer having a thickness of 1 to 40 μm on one side of the optically-transparent substrate. The hard coat layer includes an ionic liquid containing a cation and an anion, and a region between a depth of 50 nm and a depth of 700 nm from an interface of the hard coat layer on a side opposite to an optically-transparent substrate side has a peak of an abundance of the ionic liquid present in an area from the interface to the depth of 700 nm in a thickness direction of the hard coat layer.

### TECHNICAL FIELD

The present invention is related to an optical film, a method of producing the same, a polarizing plate, display panel, and display provided with the optical film.

### BACKGROUND ART

When the surface of displays of televisions or personal computers is electrostatically-charged, dusts attach on the surface to decrease visibility. In order to prevent the decrease in visibility, there are methods employed to release static electricity by providing electrical conductivity to some extent to transparent surface film to be used for displays.

Examples of providing electrical conductivity include a method of adding metal oxide microparticles in a hard coat layer to be coated on a surface film (forming electron conductive passes), a method of adding a surfactant-based anti-static agent (forming ion conductive passes), and a method of providing mesh-formed conductive passes in a surface film itself by metal or conductive polymers.

However, these methods have problems. Specifically, the method of providing mesh-formed conductive passes in a surface film itself causes deterioration of visibility of images. The method of adding metal oxide microparticles has problems that the electrical conductivity largely differs depending on the kind and content of particles and the visibility deteriorates due to the particles themselves.

A method of forming transparent conductive layer by spattering may be one way to solve these problems, however, currently, vacuuming is required point by point, which increases production cost.

The method of adding a surfactant-based anti-static agent releases static electricity via ions, in which water (moisture in air) is essential to produce ions. However, this method has a problem that the electrical conductivity significantly decreases under dried atmosphere, that is, in the situation that the amount of moisture is small, since ions are not produced.

The inventors of the present invention have filed an application for the invention that uses “ionic liquid” as an anti-static agent not having the above problems (see Patent Literature 1). The ionic liquid comprises cations and anions, is in a liquid state at ordinary temperature, and have always ions produced. Thus, by incorporating this material in a hard coat layer, ions are always produced so that removal of static electricity via ions has been possible.

In addition, a high hardness (hard coating performance) is required for a transparent surface film in order to avoid damages on display surfaces of displays, etc. at the time of handling.

### CITATION LIST

[Patent Literature 1] Japanese Patent Application Laid-Open (JP-A) No. 2008-274266

### SUMMARY OF INVENTION

### Technical Problem

The composition disclosed in Patent Literature 1 is useful and capable of imparting anti-static properties and hard coating performance by applying the composition to a substrate.

However, the inventors have found that when the ionic liquid 180 is mixed in a hard coat liquid for forming a hard coat layer and applied, the antistatic performance is exhibited, however, the ionic liquid 180 in a hard coat layer 170 is distributed to gather at the surface of the hard coat layer 170 (left figure in FIG. 8).

Hence, the inventors of the present invention has found out a new problem that when thus produced hard coat layer 170 is wiped with a waste, etc. impregnated with a solvent, or a film (hard coat layer 170) is moistened by a solvent and then wiped with a waste, etc., as shown in FIG. 8, the ionic liquid 180 come to the surface of the layer 170 and aggregated are removed, and sufficient antistatic performance cannot be obtained (right figure in FIG. 8).

It may be one way to solve the above problem that a hard coat layer 190 which functions as a cover layer is layered by sequential coating on a hard coat layer 170 having an ionic liquid 180 mixed (figure below in FIG. 9).

However, in this method, the ionic liquid 180 gathered at the surface of the hard coat layer 170 being a lower layer unevenly disperses and elutes to the cover layer 190 provided on the hard coat layer 170 due to the solvent used to form the cover layer 190 by coating. As a result, as shown in FIG. 9, there is a problem that the concentration of the anti-static agent becomes uneven on the surface of the cover layer 190 and the antistatic performance become uneven.

The present invention has been achieved in order to solve the above-stated problems. The present invention is to provide an optical film comprising a hard coat layer having hardness (hard coating performance) and property in which an anti-static agent is less likely to be removed from a hard coat layer by a solvent of a cover layer or a waste impregnated with a solvent (hereinafter, it may be referred to as wipe-off resistance to solvents), and capable of maintaining antistatic performance for a long period, a method of producing the same, and a polarizing plate, display panel and display provided with the optical film.

### Solution to Problem

The summary of the present invention is as follows.

1. An optical film comprising an optically-transparent substrate, and a hard coat layer having a thickness of 1 to 40 μm on one side of the optically-transparent substrate, wherein the hard coat layer comprises an ionic liquid containing a cation and an anion, and a region between a depth of 50 nm and a depth of 700 nm from an interface of the hard coat layer on a side opposite to an optically-transparent substrate side has a peak of an abundance of the ionic liquid present in an area from the interface to the depth of 700 nm in a thickness direction of the hard coat layer.
2. The optical film according to the above 1, wherein a half bandwidth of the peak is from 25 to 500 nm.
3. The optical film according to the above 1 or 2, wherein a percentage of the abundance of the ionic liquid present in a region between the interface and the depth of 50 nm therefrom is 50% or less with respect to the abundance of the ionic liquid present in the area from the interface to the depth of 700 nm.
4. The optical film according to any one of the above 1 to 3, wherein the cation is one or more kinds of cations selected from the group consisting of quaternary ammonium-based cations, quaternary phosphonium-based cations, imidazolium-based cations, pyridinium-based cations and pyrrolidinium-based cations.
5. The optical film according to any one of the above 1 to 4, wherein the surface resistance value of the hard coat layer is 1.0×10¹³Ω/□ or less.
6. The optical film according to any one of the above 1 to 5, wherein a low refractive index layer is provided on the side opposite to the optically-transparent substrate side of the hard coat layer.
7. A method of producing an optical film comprising the steps of: (i) preparing an optically-transparent substrate; (ii) preparing a first curable resin composition for a hard coat layer comprising an ionic liquid containing a cation and an anion, a first curable resin and a first solvent, and a second curable resin composition for the hard coat layer comprising a second curable resin and a second solvent; (iii) simultaneously coating at least the first curable resin composition for the hard coat layer and the second curable resin composition for the hard coat layer on one side of the optically-transparent substrate adjacently from an optically-transparent substrate side to form a coating layer; and (iv) drying and curing the coating layer obtained in the step (iii).
8. The method of an optical film according to the above 7, wherein the cation is one or more kinds of cations selected from the group consisting of quaternary ammonium-based cations, quaternary phosphonium-based cations, imidazolium-based cations, pyridinium-based cations and pyrrolidinium-based cations.
9. A polarizing plate comprising the optical film defined by any one of the above 1 to 6 and a polarizing element provided on the optically-transparent substrate side of the optical film.
10. A display panel provided with the optical film defined by any one of the above 1 to 6.
11. A display panel provided with the polarizing plate defined by the above 10.
12. A display provided with the optical film defined by any one of the above 1 to 6.
13. A display provided with the display panel defined by the above 11.
14. A display provided with the display panel defined by the above 12.

### Advantageous Effects of Invention

The present invention provides an optical film having hardness and wipe-off resistance to an ionic liquid, and capable of maintaining antistatic performance for a long period, a method of producing the same, and a polarizing plate, display panel and display provided with the optical film.

### BRIEF DESCRIPTION OF DRAWINGS

FIG. 1 is a view schematically showing an example of a cross-sectional surface of a first embodiment of the optical film of the present invention.

FIG. 2 is a view schematically showing an example of a cross-sectional surface of a second embodiment of the optical film of the present invention.

FIG. 3 is a view schematically showing an example of a cross-sectional surface of a third embodiment of the optical film of the present invention.

FIG. 4 is a view schematically showing an example of a method of simultaneous coating using an extrusion-type die coater.

FIG. 5 is a view schematically showing an example of a cross-sectional surface of a polarizing plate of the present invention.

FIG. 6 is a graph showing a distribution of sulfur atoms in the depth direction of hard coat layers of Examples 1 to 3.

FIG. 7 is a graph showing a distribution of sulfur atoms in the depth direction of hard coat layers of Comparative examples 1 to 3.

FIG. 8 is a schematic view of a conventional hard coat layer having an ionic liquid, the surface of which is wiped off with a solvent.

FIG. 9 is a schematic view of a conventional hard coat layer having an ionic liquid, the surface of which is provided with a cover layer.

### DESCRIPTION OF EMBODIMENTS

Hereinafter, firstly, an optical film of the present invention will be explained. Next, a method of producing the optical film, a polarizing plate, a display panel and a display of the present invention will be explained.

In the present invention, (meth)acrylate means acrylate and/or methacrylate. (meth)acrylic acid means acrylic acid and/or methacrylic acid.

In the present invention, “hard coat layer” means a layer which has a hardness of “H” or more on the pencil hardness test with a load of 4.9 N defined in JIS K5600-5-4 (1999).

In the present invention, “average particle diameter of microparticles (including high refractive index microparticles)” means, in the case of microparticles in a composition, an averaged value of diameters of particles in a liquid measured by a dynamic light scattering method by means of Microtrac particle size analyzer (product name; manufactured by: Nikkiso Co., Ltd.), etc. In the case of microparticles in a hard coat layer, it is an averaged value of diameters of 20 particles in the cross-sectional surface of a hard coat layer observed in a transmission electron microscope (TEM) image.

In the present invention, in the case where a compound has no molecular weight distribution, “molecular weight” means the molecular weight of the compound itself. In the case where a compound has a molecular weight distribution, “molecular weight” means a polystyrene-equivalent weight average molecular weight (Mw) measured by gel permeation chromatography (GPC) (product name: HLC-8220GPC) using a THF solvent and data analysis software (manufactured by: Tosoh Corporation). For polydisperse system of Ni molecules (i=1, 2, 3 . . . ; the number of molecule is Ni) having a molecular weight Mi, the weight average molecular weight (Mw) is calculated by the following Formula (I).

$${M}_{w} = \frac{\sum {M}_{i}^{2} {N}_{i}}{\sum {M}_{i} {N}_{i}} \qquad Formula ( 1 )$$

### (Optical Film)

The optical film of the present invention comprises an optically-transparent substrate, and a hard coat layer having a thickness of 1 to 40 μm on one side of the optically-transparent substrate, wherein

the hard coat layer comprises an ionic liquid containing a cation and an anion, and

a region between a depth of 50 nm and a depth of 700 nm from an interface of the hard coat layer on a side opposite to an optically-transparent substrate side has a peak of an abundance of the ionic liquid present in an area from the interface to the depth of 700 nm in a thickness direction of the hard coat layer.

As described above, the ionic liquid exhibiting anti-static properties is not eccentrically located in the region between the surface of the hard coat layer and the depth of 50 nm, and a good deal of ionic liquid is present in the region between the specific depths (50 nm and 700 nm) from the surface of the hard coat layer. Thereby, the hard coat layer has wipe-off resistance to solvents, and as a result, a sufficient antistatic performance can be maintained for a long term.

The “peak” means a point having the most abundance compared to the vicinity (the maximum point).

In the present invention, it is only necessary that the peak of the abundance of the ionic liquid is present between the above specific depths, and less ionic liquid than the peak abundance may be present in the region between the surface and the depth of 50 nm therefrom of the hard coat layer, or the ionic liquid may be absent.

In a suitable embodiment of the optical film of the present invention, it is possible that the half bandwidth of the peak is from 25 to 500 nm.

By having the half bandwidth within the above range, the ionic liquid is eccentrically located in the region between the specific depths (50 nm and 700 nm) from the surface (the interface on the side opposite to the optically-transparent substrate side) of the hard coat layer. Thereby, both high antistatic performance and wipe-off resistance to solvents are exhibited.

In a suitable embodiment of the optical film of the present invention, the percentage of the abundance of the ionic liquid present in a region between the interface and the depth of 50 nm therefrom can be 50% or less with respect to the abundance of the ionic liquid present in the area from the interface to the depth of 700 nm. In more suitable embodiment, the percentage of the abundance of the ionic liquid present in the region between the interface and the depth of 50 nm therefrom with respect to the abundance of the ionic liquid present in the region between the interface and the depth of 600 nm can be 50% or less. In even more suitable embodiment, the percentage of the abundance of the ionic liquid present in the region between the interface and the depth of 50 nm can be 30% or less.

Thereby, the antistatic performance of the hard coat layer can be efficiently increased.

The percentage of the abundance of the ionic liquid present in the above specific regions can be measured as follows by means of X ray photoelectron spectroscopy (XPS) (product name: ESCA-3400; manufactured by: KRATOS).

The XPS is an analysis method that the surface of a solid sample is irradiated with X ray, and the kinetic energy of photoelectron generated by photoelectric effect is measured, wherein by measuring the observed strength of photoelectron peak, the kind and concentration of elements consisting the surface of the sample can be measured. In the present invention, Mg anode is used as X ray sourse.

Specifically, the sample (hard coat layer) is etched by ion sputtering (Ar⁺ is irradiated; ion gun for sputtering used is “high-speed ion gun (Kaufman-type ion gun)”) to expose a part of the specific depth and perform XPS measurement of the exposed part of the specific depth. Then, the peaks of C (from 265 to 305), N (from 380 to 420), O (from 510 to 550), S (from 145 to 185) and F (from 665 to 705) are selected from peaks (Binding Energy (B.E.) unit [eV]) specific to elements observed at the exposed part of the specific depth, and the abundance of each of five elements is calculated from each peak area with respect to 100% of total calculated abundance of the above five elements. The XPS measurement is performed for the area to be measured from the interface of the hard coat layer (to the depth of 700 nm). Then, focusing on a particular element contained only in the ionic liquid to be measured among the five elements, the total amount S1 of the content of the particular element in the area to be measured from the interface (to the depth of 700 nm) and the total amount S2 of the particular element in the region to be measured between the interface and the depth of 50 nm are used to calculate the ratio of S2 with respect to S1. Thereby, the percentage of the abundance of the ionic liquid present in the region between the interface and the depth of 50 nm can be obtained with respect to the abundance of the ionic liquid present in the predetermined area from the interface (to the depth of 700 nm).

Besides the above, there is a method of subjecting an arbitrary part of the cross-sectional surface of a film to EDX (element assay).

In the hard coat layer, the peak of the abundance of the ionic liquid is present in the region between the depth of 50 m and the depth of 700 nm from the surface of the hard coat layer. From 80 to 700 nm from the surface of the hard coat layer is preferable, more preferably from 100 to 600 nm, from the viewpoint of wipe-off resistance to solvents and antistatic performance.

FIG. 1 is a view schematically showing an example of a cross-sectional surface of a first embodiment of the optical film of the present invention.

In the optical film 1 in FIG. 1, the hard coat layer 20 having a thickness of 1 to 20 μm is provided on one side of the optically-transparent substrate 10. In the hard coat layer 20, the ionic liquid 30 is contained, and the region between the depth of 50 nm and the depth of 700 nm from the interface 40 of the hard coat layer 20 (it may be referred to as “the surface of the hard coat layer”) on the side opposite to the optically-transparent substrate 10 side has the peak of the abundance of the ionic liquid 30 present in the area from the interface 40 to the depth of 700 nm in the layer thickness direction of the hard coat layer (hereinafter, it may be referred to as “thickness direction”). That is, there are more ionic liquid 30 present in the region between the depth of 50 nm and the depth of 700 nm from the interface 40 than in the region between the interface 40 and the depth of 50 nm.

In the first embodiment of the optical film of the present invention, the ionic liquid 30 exhibiting anti-static properties is not eccentrically located in the region between the interface 40 and the depth of 50 nm therefrom, and a good deal of ionic liquid is present in the region between the specific depths from the interface 40 of the hard coat layer 20. Thereby, the hard coat layer 20 can have wipe-off resistance to solvents, and a sufficient antistatic performance can be maintained for a long term.

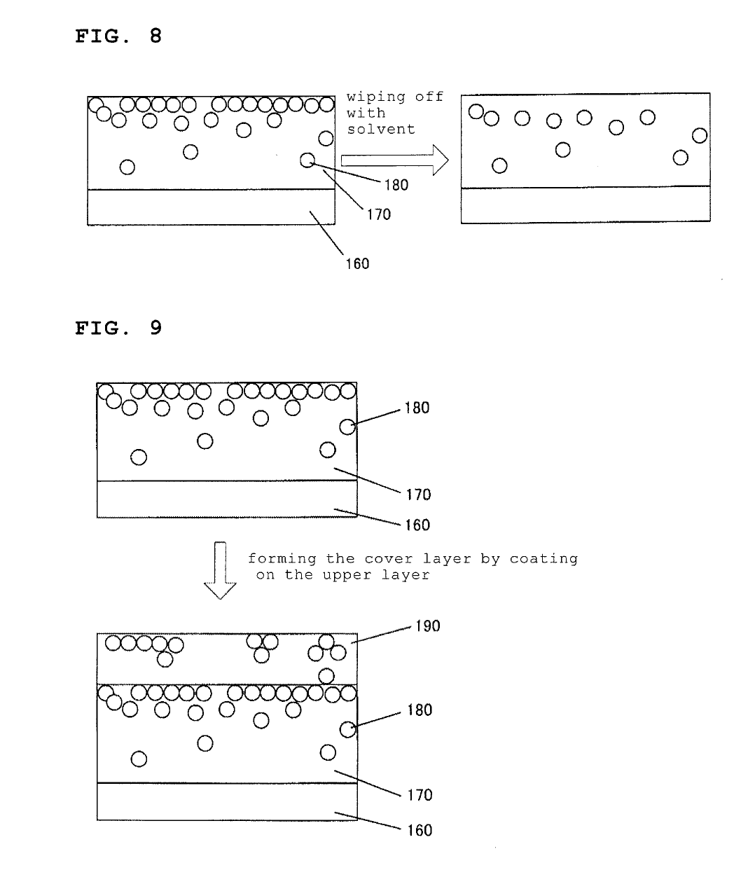

To simplify the explanation, FIGS. 1 to 9 are schematic views accordingly altering the aspect ratio and the dimensional ratio of layers from the actual size to exaggerate.

Hereinafter, essential components of the optical film of the present invention, the optically-transparent substrate, the hard coat layer and the low refractive index layer, which may be provided as needed, will be described.

### (Optically-Transparent Substrate)

The optically-transparent substrate used for the optical film of the present invention is an object or a support, on which various functional layers are layered.

Thus, the optically-transparent substrate may not be particularly limited in its kind as long as it has transparency to visible light and capable of layering various functional layers thereon.

Specifically, the optically-transparent substrate may be a film made of a resin, and examples of the resin include polyesters such as polyethylene terephthalate (PET; refractive index: 1.575) and polyethylene naphthalate (PEN); polyolefins such as cyclic polyolefins, polyethylene, polypropylene and polystyrene; vinyl-based resins such as polyvinyl chloride and polyvinylidene chloride; polycarbonates; acrylic resins such as polymethacrylate; cellulose resins such as diacetyl cellulose, triacetyl cellulose (TAC; refractive index: 1.475) and cellulose acetate; polyamide resins such as Nylon-6 and Nylon-6′6; polyimide resins; polyvinyl alcohols, ethylene vinyl alcohols, polyether sulfones, and polyether ketones.

Besides the above, an amorphous olefin polymer film having an alicyclic structure (Cyclo-Olefin-Polymer, COP) may also be used as the optically-transparent substrate, which is a substrate made of any of norbornene-based polymers, monocyclic cyclic olefin-based polymers, cyclic conjugated diene-based polymers, and vinyl alicyclic hydrocarbon polymer resins. Examples include ZEONEX and ZEONOR (product name; manufactured by: Zeon Corporation; norbornene-based resin), Sumilite FS-1700 (product name; manufactured by: Sumitomo Bakelite Co., Ltd.), ARTON (product name; manufactured by: JSR CORPORATION; modified norbornene-based resin), APEL (product name; manufactured by: Mitsui Chemicals, Inc.; cyclic olefin copolymer), Topas (product name; manufactured by: Ticona; cyclic olefin copolymer), and OPTOREZ OZ-1000 series (product name; manufactured by: Hitachi Chemical Co., Ltd.; alicyclic acrylic resin). Also, as an alternative substrate of TAC, FV series (product name; manufactured by: Asahi Kasei Chemicals Corporation; film with low refractive index and low photoelasticity) is preferable.

A single layer or a laminate of the same or different kinds from the above material may be used as the optically-transparent substrate.

Physical treatment such as corona discharge treatment or oxidation treatment, or application of an anchor agent or coating called a primer may be preliminarily performed on the optically-transparent substrate upon forming the hard coat layer on the optically-transparent substrate to improve the adhesion.

As the transparency of the optically-transparent substrate, the light transmittance of the visible region of 80% or more is preferable in the case of a single-layer optically-transparent substrate. Having the transparency is preferably colorless transparent, but may not be limited thereto, and it may be colored transparent to the extent which does not prevent the object of the present invention. The light transmittance in the visible region is preferable as high as possible. Taking the fact that a final product requires a light transmittance of 50% or more and two or more sheets are layered, an optically-transparent substrate having a light transmittance of 80% fits the purpose. The light transmittance of a single optically-transparent substrate is more preferably 85% or more, even more preferably 90% or more, since the higher the light transmittance is, the more optically-transparent substrates can be layered. To improve light transmittance, decreasing the thickness may be one effective means.

The thickness of the optically-transparent substrate may not be limited if the transparency is fulfilled. From the viewpoint of workability, the thickness of the optically-transparent substrate is preferably from about 12 to 300 μm. If the thickness is 12 μm or more, there is an advantage of easy handling in the production process. On the other hand, if the thickness is 300 μm or less, the flexibility of film can be sufficiently obtained, the continuous take-up can be performed in each process, and the workability upon layering plural optically-transparent substrates can be excellent.

If necessary, the optically-transparent substrate having known additives added, for example, an anti-static agent, an UV absorbing agent, an infrared light absorbing agent, a plasticizer, a lubricant, a coloring agent, an oxidation inhibitor, a fire retardant, etc. to add function may also be used.

### (Hard Coat Layer)

The hard coat layer of the optical film of the present invention comprises the ionic liquid containing a cation and an anion, and the region between the depth of 50 nm and the depth of 700 nm from the interface of the hard coat layer on the side opposite to the optically-transparent substrate side has the peak of the abundance of the ionic liquid present in the area from the interface to the depth of 700 nm in the thickness direction of the hard coat layer having a thickness of 1 to 40 μm.

The hard coat layer of the present invention generally is a cured product of a curable resin composition for a hard coat layer (hereinafter, it may be simply referred to as “HC-layer composition”) comprising at least the curable resin and the ionic liquid. The hard coat layer of the optical film of the present invention consists of a cured product of the HC-layer composition comprising the curable resin and the ionic liquid, thus, the hard coat layer has high antistatic performance and hardness. Further, there is the aforementioned specific distribution of the ionic liquid in the thickness direction of the hard coat layer, thus, the hard coat layer has wipe-off resistance to solvents and is capable of maintaining sufficient antistatic performance for a long time.

Hereinafter, the curable resin and the ionic liquid being essential components of the HC-layer composition, and other components, which may be contained if necessary such as a solvent, will be explained in order.

### (Curable Resin)

In the present invention, monomers, oligomers and prepolymers having one or more functional groups curable by heat and/or ionizing radiation can be used as the curable resin.

Examples of the functional group include condensable groups and reactive groups such as a hydroxyl group, an anhydride group, a carboxyl group, an amino group, an imino group, an epoxy group, a glycidyl group, and an isocyanate group. The examples also include polymerizable groups including alkenyl groups having 2 to 6 carbon atoms such as a vinyl group, a propenyl group, an isopropenyl group, a butenyl group, and an allyl group; alkynyl groups having 2 to 6 carbon atoms such as an ethynyl group, a propynyl group, and a butynyl group; alkenylidene groups having 2 to 6 carbon atoms such as vinylidene; and a (meth)acryloyl group, which means a methacryloyl group or an acryloyl group. Among the above functional groups, polymerizable groups are particularly preferable.

The number of functional groups in one molecule of the curable resin is preferably two or more from the viewpoint of increasing hardness of the hard coat layer by crosslinking between curable resins.

Examples of the curable resin having the polymerizable group include compounds having a radical polymerizable group.

Examples of the compounds having a radical polymerizable group include (meth)acrylate monomers, polyester monomers, polyether monomers, epoxy monomers, urethane monomers, alkyd monomers, spiroacetal monomers, polybutadiene monomers, polythiolpolyene monomers, and (meth)acrylic acid esters of multifunctional compounds such as polyalcohols, having a relatively low molecular weight (for example, molecular weight from 80 to 2,000).

Specific examples of the (meth)acrylate monomers include ethyl (meth)acrylate, ethylhexyl (meth)acrylate, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

Besides the above, any of monofunctional or multifunctional monomers such as styrene, methylstyrene and N-vinylpyrrolidone, and monomers such as bisphenol-type epoxy compounds, novolac-type epoxy compounds, aromatic vinyl ethers, and aliphatic vinyl ethers may be used.

Also, any of multifunctional monomers such as ethylene glycol di(meth)acrylate, 1,4-dicyclohexane di(meth)acrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, and pentaerythritol hexa(meth)acrylate; epoxy-based oligomers such as bisphenol-type epoxy resins, and novolac-type epoxy compounds; and cyclic ether bond-containing oligomers including vinyl ether oligomers such as fatty acid vinyl ethers and aromatic vinyl ethers, may be used.

As the heat-curable resin, any of monomers and oligomers having a heat-curable group may be used. Examples of the heat-curable group include an alkoxy group, a hydroxyl group, a carboxyl group, an amino group, an epoxy group, an isocyanato group, an aziridine group, an oxazoline group, an aldehyde group, a carbonyl group, a hydrazine group, a vinyl group, a cyano group, a methylol group and an active methylene group.

The heat-curable group may be a functional group which is a reactive functional group with a blocking agent bonded and a decomposition reaction of the blocking agent progresses exhibiting polymerization capability and crosslinking ability when heated, such as a block isocyanato group.

Also, as the heat-curable resin, any of organometallic compounds usually used as coupling agents such as organosilicon compounds (silicon alkoxide and silane coupling agents), organotitanium compounds (titanate coupling agents) and organoaluminum compounds may be used.

Examples of the organosilicon compounds include methyltrimethoxysilane, methyltriethoxysilane, methyltrimethoxyethoxysilane, 3-glycidoxypropyltrimethoxysilane, and 3-aminopropyltrimethoxysilane. Among the above organosilicon compounds, organosilicon compounds having a reactive group are likely to cause a curing reaction with other monomers or oligomers and bond strongly, thus, the hardness of hard coat layer to be obtained improves.

Examples of the organotitanium compounds include tetramethoxytitanium, and tetraethoxytitanium.

Further, if necessary, reactive polymers having a weight average molecular weight of 20,000 or more and having a (meth)acrylate group in the main or side chain, etc. may be preferably used. These reactive polymers are commercially available, for example, “Macro monomer” (product name, manufactured by Toagosei Co., Ltd.). In addition, a reactive polymer having a (meth)acrylate group is obtainable, for example, by preliminarily preparing a copolymer of (meth)acrylic acid and glycidyl methacrylate, and then, condensing the glycidyl group of the copolymer and the carboxyl group of the (meth)acrylic acid.

By containing such a large component having a weight average molecular weight of 20,000 or more by 10 to 80% by mass with respect to the total mass of the curable resin, it is possible to improve layer-forming characteristics toward complicated shapes and decrease curl or curve of optical film due to volume contraction upon curing.

In the case of using a permeable solvent hereinafter described, the molecular weight of the curable resin is preferably 1,000 or less from the viewpoint of easier permeation of the curable resin into a TAC substrate.

Examples of such a curable resin include pentaerythritol tri(meth)acrylate and dipentaerythritol hexa(meth)acrylate.

The curable resin may be one kind alone or a combination of two or more kinds selected from the above curable resins may be used.

The content of the curable resin in the HC-layer composition may be accordingly adjusted if needed, but is preferably from 50 to 99% by mass, more preferably from 70 to 97% by mass, with respect to the total mass (excluding a solvent) of the HC-layer composition, from the viewpoint of imparting a sufficient hardness as the hard coat layer, being capable of containing a sufficient amount of ionic liquid, and having both antistatic performance and hardness at the same time.

### (Ionic Liquid Having Anti-Static Properties)

In the present invention, the ionic liquid means a liquid consisting of a cation(s) and an anion(s) which is in the liquid state at ordinary temperature (from 23 to 25° C.). The ionic liquid used in the present invention has at least anti-static properties, and may have high ion conductivity, high thermal stability, appropriate viscosity, low vapor pressure, no inflammability and combustibility, a wide range of liquid temperature, etc. selected according to required performance.

In the case of using a method of simultaneous coating hereinafter described, it is sufficient if the ionic liquid is contained only in the first HC-layer composition, which becomes a lower layer of the hard coat layer after curing, which is regarded that the HC-layer composition contains the ionic liquid. It is not necessary that the second HC-layer composition contains the ionic liquid.

In the optical film according to the present invention, the cation is preferably one or more kinds of cations selected from the group consisting of quaternary ammonium-based cations, quaternary phosphonium-based cations, imidazolium-based cations, pyridinium-based cations and pyrrolidinium-based cations from the viewpoint of solubility and anti-static properties. The cation is more preferably the quaternary phosphonium-based cations, the imidazolium-based cations and the pyridinium-based cations from the viewpoint of solubility and anti-static properties. Among the above, the quaternary phosphonium-based cations are even more preferable since thermal stability, light resistance and transparency are excellent.

Examples of the cation include the following quaternary ammonium-based cation represented by Formula (I), quaternary phosphonium-based cation represented by Formula (II), imidazolium-based cation represented by Formula (III), pyridinium-based cation represented by Formula (IV) and pyrrolidinium-based cation represented by Formula (V):

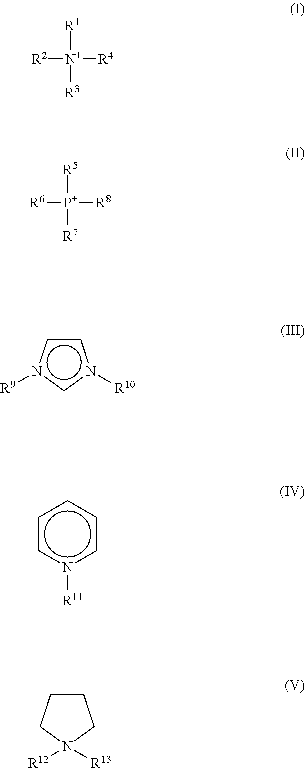

wherein each of R¹ to R¹¹ may be the same or different from each other and represents a saturated aliphatic group or R³ and R⁴ may form an aliphatic hetero ring together with a bonded nitrogen atom; the total number of carbon atoms of R¹ to R⁴ and R⁵ to R⁸ are respectively 6 or more, that of R⁹ and R¹⁰ are respectively 3 or more, and R¹¹ has 2 or more carbon atoms; each of R¹² and R¹³ is independently a saturated aliphatic group of 1 to 12 carbon atoms.

The saturated aliphatic groups represented by R¹ to R¹³ may be linear or branched. The examples include a methyl group, an ethyl group, a propyl group, an isopropyl group, a butyl group, an isobutyl group, a sec-butyl group, a tert-butyl group, a hexyl group, an octyl group, and a decyl group. Further, the above exemplified groups may include groups containing a hetero atom such as S, O, etc. by bonds represented by —S—, —O—, etc., wherein R¹¹ has 2 or more carbon atoms selected from the above. The saturated aliphatic group is preferably an alkyl group having 1 to 8 carbon atoms, more preferably an alkyl group having 1 to 4 carbon atoms.

Examples of R³ and R⁴ forming an aliphatic hetero ring together with a bonded nitrogen atom include a pyrrolidine ring, a piperidine ring, a diazepine ring, a piperazine ring, and a morpholine ring. Among the above, five- to six-membered aliphatic hetero rings are preferable.

The quaternary ammonium-based cation represented by Formula (I) is preferably a cation wherein each of R¹ and R² is a methyl or ethyl group, R³ is an alkyl group having 1 to 4 carbon atoms, and R⁴ is an alkyl group having 1 to 8 carbon atoms. More preferable quaternary ammonium-based cations represented by Formula (I) are: a cation (TMPA) wherein each of R¹ to R³ is a methyl group, and R⁴ is a propyl group; a cation wherein each of R¹ and R² is a methyl group, R³ is an isopropyl group, and R⁴ is a hexyl group; and a cation wherein R¹ is a methyl group, each of R² and R³ is an ethyl group, and R⁴ is a 2-methoxyethyl group.

When R³ and R⁴ form the aliphatic hetero ring together with the bonded nitrogen atom, preferable examples of the quaternary ammonium-based cation represented by Formula (I) include: a cation wherein R¹ is a methyl group, R² is an ethyl group, and R³ and R⁴ form a pyrrolidine ring together with a bonded nitrogen atom; and a cation (BMP) wherein R¹ is a methyl group, R² is a butyl group, and R³ and R⁴ form a pyrrolidine ring together with a bonded nitrogen atom.

The quaternary phosphonium-based cation represented by Formula (II) is preferably a cation wherein each of R⁵ and R⁶ is independently a methyl group or an ethyl group, R⁷ is an alkyl group having 1 to 4 carbon atoms, and R⁸ is an alkyl group having 1 to 8 carbon atoms.

The imidazolium-based cation represented by Formula (III) is preferably a cation wherein each of R⁹ and R¹⁰ is independently an alkyl group having 1 to 4 carbon atoms. A cation (EMI) wherein R⁹ is a methyl group and R¹⁰ is an ethyl group, and a cation (BMI) wherein R⁹ is a methyl group and R¹⁰ is a butyl group are more preferable.

The pyridinium-based cation represented by Formula (IV) is preferably a cation wherein R¹¹ is an alkyl group having 2 to 8 carbon atoms, more preferably a cation (BP) wherein R¹¹ is a butyl group.

The pyrrolidinium-based cation represented by Formula (V) is preferably a cation wherein each of R¹² and R¹³ is an alkyl group having 1 to 8 carbon atoms, more preferably a cation wherein R¹² is a butyl group.

Examples of the quaternary ammonium-based cation include symmetry ammoniums such as tetramethylammonium, tetraethylammonium, and tetrapropylammonium. Preferable examples include ammoniums in which the number of carbon atoms of minimal-length substituent is 50% or more and less than 100% of that of maximal-length substituent (hereinafter, it may be referred to as pseudo-symmetry ammoniums) such as ethyltrimethylammonium, vinyltrimethylammonium, triethylmethylammonium, triethylpropylammonium, diethyldimethylammonium, tributylethylammonium, triethylisopropylammonium, N,N-dimethylpyrrolidinium, N-methyl-N-ethylpyrrolidinium, N-methyl-N-propylpyrrolidinium, N-methyl-N-butylpyrrolidinium, N-methyl-N-ethylpiperidinium, N-methyl-N-propylpiperidinium, N-methyl-N-butylpiperidinium, triethylmethoxymethylammonium, dimethylethylmethoxyethylammonium, dimethylethylmethoxymethylammonium, diethylmethylmethoxyethylammonium, and diethylmethylmethoxymethylammonium. Besides the above, examples of the quaternary ammonium-based cation include asymmetry ammoniums such as trimethylpropylammonium, trimethylisopropylammonium, butyltrimethylammonium, allyltrimethylammonium, hexyltrimethylammonium, octyltrimethylammonium, dodecyltrimethylammonium, triethylmethoxyethoxymethylammonium, and dimethyldipropylammonium.

The ionic liquid containing quaternary phosphonium-based cations and anions is preferably quaternary phosphonium salts. The specific examples include triethyl(methoxymethyl)phosphonium.bis(trifluoromethylsulfonyl)imide, triethyl(methoxymethyl)phosphonium.tetrafluoroborate, triethyl(methoxymethyl)phosphonium.hexafluorophosphate, triethyl(methoxymethyl)phosphonium.trifluoromethane sulfonate, triethyl(methoxymethyl)phosphonium.bis(fluorosulfonyl)imide, triethyl(methoxymethyl)phosphonium.thiocyanate, triethyl(methoxymethyl)phosphonium.dicyanamide, triethyl(methoxymethyl)phosphonium.dialkyl phosphates, triethyl(2-methoxyethyl)phosphonium.bis(trifluoromethylsulfonyl)imide, triethyl(methoxymethyl)phosphonium.tetrafluoroborate, triethyl(2-methoxyethyl)phosphonium.tetrafluoroborate, triethyl(2-methoxyethyl)phosphonium.hexafluorophosphate, triethyl(2-methoxyethyl)phosphonium.trifluoromethane sulfonate, triethyl(2-methoxyethyl)phosphonium.bis(fluorosulfonyl)imide, triethyl(2-methoxyethyl)phosphonium.thiocyanate, triethyl(2-methoxyethyl)phosphonium.dicyanamide, triethyl(2-methoxyethyl)phosphonium.dialkyl phosphates, diethylmethyl(methoxymethyl)phosphonium.bis(trifluoromethylsulfonyl)imide, diethylmethyl(methoxymethyl)phosphonium.tetrafluoroborate, diethylmethyl(methoxymethyl)phosphonium.dicyanamide, diethylmethyl(2-methoxyethyl)phosphonium.bis(trifluoromethylsulfonyl)imide, diethylmethyl(2-methoxyethyl)phosphonium.tetrafluoroborate, diethylmethyl(2-methoxyethyl)phosphonium.dicyanamide, tri-n-propyl(methoxymethyl)phosphonium.bis(trifluoromethylsulfonyl)imide, tri-n-propyl(2-methoxyethyl)phosphonium.bis(trifluoromethylsulfonyl)imide, tri-n-butyl(methoxymethyl)phosphonium.bis(trifluoromethylsulfonyl)imide, tri-n-butyl(methoxymethyl)phosphonium.tetrafluoroborate, tri-n-butyl(methoxymethyl)phosphonium.dicyanamide, tri-n-butyl(2-methoxyethyl)phosphonium.bis(trifluoromethylsulfonyl)imide, tri-n-butyl(2-methoxyethyl)phosphonium.tetrafluoroborate, tri-n-butyl(2-methoxyethyl)phosphonium.dicyanamide, tri-n-pentyl(methoxymethyl)phosphonium-bis(trifluoromethylsulfonyl)imide, tri-n-pentyl(2-methoxyethyl)phosphonium.bis(trifluoromethylsulfonyl)imide, tri-n-hexyl(methoxymethyl)phosphonium.bis(trifluoromethylsulfonyl)imide, and tri-n-hexyl(2-methoxyethyl)phosphonium.bis(trifluoromethylsulfonyl)imide. Among the above, preferable examples include triethyl(methoxymethyl)phosphonium.bis(trifluoromethylsulfonyl)imide, triethyl(methoxymethyl)phosphonium.tetrafluoroborate, triethyl(methoxymethyl)phosphonium.dicyanamide, triethyl(2-methoxyethyl)phosphonium.bis(trifluoromethylsulfonyl)imide, triethyl(2-methoxyethyl)phosphonium.tetrafluoroborate, triethyl(2-methoxyethyl)phosphonium.dicyanamide, tri-n-butyl(methoxymethyl)phosphonium.bis(trifluoromethylsulfonyl)imide, and tri-n-butyl(2-methoxyethyl)phosphonium.bis(trifluoromethylsulfonyl)imide from the viewpoint of low viscosity, basicity resistance and heat resistance.

Specific examples of the ionic liquid containing imidazolium-based cations and anions include 1,3-dimethylimidazolium.chloride, 1,3-dimethylimidazolium.dimethyl phosphate, 1-ethyl-3-methylimidazolium.chloride, 1-ethyl-3-methylimidazolium.bromide, 1-ethyl-methylimidazolium.iodide, 1-ethyl-3-methylimidazolium.trifluoromethane sulfonate, 1-ethyl-3-methylimidazolium p-toluene sulfonate, 1-ethyl-3-methylimidazolium.ethyl sulphate, 1-ethyl-3-methylimidazolium.2-methyl(2-methoxyethoxy)ethyl sulphate, 1-ethyl-3-methylimidazolium.dicyanamide, 1-ethyl-3-methylimidazolium.tetrafluoroborate, 1-ethyl-3-methylimidazolium.hexafluorophosphate, 1-ethyl-3-methylimidazolium.bis(trifluoromethanesulfonyl)imide, 1-methyl-3-propylimidazolium.iodide, 1-butyl-3-methylimidazolium.chloride, 1-butyl-3-methylimidazolium.bromide, 1-butyl-3-methylimidazolium.iodide, 1-butyl-3-methylimidazolium.trifluoromethane sulfonate, 1-butyl-3-methylimidazolium.tetrafluoroborate, 1-butyl-3-methylimidazolium.hexafluorophosphate, 1-butyl-3-methylimidazolium.bis(trifluoromethanesulfonyl)imide, 1-butyl-3-methylimidazolium.tetrachloroferrate, 1-hexyl-3-methylimidazolium.chloride, 1-hexyl-3-methylimidazolium-hexafluorophosphate, 1-hexyl-3-methylimidazolium.tetrafluoroborate, 1-butyl-2,3-dimethylimidazolium.chloride, 1-butyl-2,3-dimethylimidazolium.tetrafluoroborate, and 1-butyl-2,3-dimethylimidazolium.hexafluorophosphate. Among the above, 1-ethyl-3-methylimidazolium.trifluoromethane sulfonate, which exhibits high ion conductivity, is preferable.

Specific examples of the ionic liquid containing pyridinium-based cations and anions include 1-ethylpyridinium.chloride, 1-ethylpyridinium.bromide, 1-butylpyridinium.chloride, 1-butylpyridinium.bromide, 1-butylpyridinium.hexafluorophosphate, 1-butyl-4-methylpyridinium.bromide, 1-butyl-4-methylpyridinium.hexafluorophosphate, 1-ethyl-3-methylpyridinium.ethyl sulphate, and 1-ethyl-3-(hydroxymethyl)pyridinium.ethyl sulphate. Among the above, 1-ethyl-3-(hydroxymethyl)pyridinium.ethyl sulphate is preferable from the viewpoint of exhibiting high ion conductivity.

Specific examples of the ionic liquid containing pyrrolidinium-based cations and anions include 1-butyl-1-methylpyrrolidinium.bis(trifluoromethane sulfonyl)imide.

Examples of anion in the ionic liquid include halogens, triflate, tetrafluoroborate and hexafluorophosphate.

The content of ionic liquid is preferably 1% by mass or more, more preferably 3% by mass or more, with respect to the total mass (excluding solvent) of the HC-layer composition from the viewpoint of imparting sufficient anti-static properties to the hard coat layer. The content of ionic liquid is preferably 50% by mass or less, more preferably 30% by mass or less, with respect to the total mass (excluding solvent) of the HC-layer composition from the viewpoint of increasing the content of the curable resin and obtaining sufficient hardness of the hard coat layer.

The layer thickness of the hard coat layer is from 1 to 40 μm, preferably form 1 to 20 μm.

The surface resistance value of the hard coat layer is preferably 1.0×10¹³Ω/□ or less, more preferably 1.0×10¹¹Ω/□ or less.

### (Other Components)

In the present invention, the HC-layer composition may contain other components besides the above essential components (the curable resin and ionic liquid) such as a solvent, a photoinitiator, a photosensitization agent, a photopolymerization accelerator and microparticles, if necessary.

### (Solvent)

The solvent is not particularly limited if it is a solvent capable of uniformly dissolving or dispersing components other than the solvent such as at least the curable resin and the ionic liquid, and any of conventionally known solvents can be used.

Examples of the solvent include alcohols such as methanol, ethanol, and isopropyl alcohol; ketones such as acetone, methyl ethyl ketone (MEK), methyl isobutyl ketone (MIBK), and cyclohexanone; esters such as methyl acetate, ethyl acetate, and butyl acetate; ethers such as dioxane, tetrahydrofuran, and diisopropyl ether; glycols such as ethylene glycol, and propylene glycol; aliphatic hydrocarbons such as hexane; glycol ethers such as ethyl cellosolve, and ethyl carbitol; halogenated hydrocarbons; aromatic hydrocarbons such as toluene, and xylene; amides such as dimethyl formamide, and dimethyl acetoamide; and sulfoxides such as dimethyl sulfoxide. Among the above, ketones and esters are suitably used from the viewpoint of boiling point, and the solubility or dispersibility of the curable resin.

In the case that the optically-transparent substrate is a TAC substrate, a solvent capable of penetrating into the TAC substrate (hereinafter, it may be referred to as “penetrating solvent”) is preferably used to inhibit generation of interference fringe due to the refractive index difference at the interface between the TAC substrate and the hard coat layer. It is presumed that generation of interference fringe is inhibited as above due to the following: the permeable solvent dissolves or swells the TAC substrate, the curable resin becomes easier to permeate into the TAC substrate, the interface between the TAC substrate and the hard coat layer becomes unclear, and the refractive index difference at the interface between the TAC substrate and the hard coat layer decreases.

Examples of preferable permeable solvent include ketones such as methyl ethyl ketone.

The solvent may be one kind alone or two or more kinds may be used in combination.

The content of solvent in the HC-layer composition may be accordingly adjusted so that other components besides the solvent can be uniformly dissolved or dispersed.

The content of solvent is, for example, preferably from 20 to 99.5% by mass, more preferably from 30 to 70% by mass, with respect to the total mass of the HC-layer composition from the viewpoint of dispersion stability and long-term storage stability of the HC-layer composition.

### (Photoinitiator)

In the case of using an ionizing-radiation curable resin as the curable resin, it is desirable to use a photoinitiator to start polymerization.

The photoinitiator is not particularly limited. The examples include acetophenones, benzophenones, ketals, anthraquinones, disulfide compounds, thiuram compounds, and fluoroamine compounds. More specific examples include 1-hydroxy-cyclohexyl-phenyl ketone, 2-methyl-1-[4-(methylthio)phenyl]-2-morpholinopropan-1-one, benzyl dimethyl ketone, 1-(4-dodecylphenyl)-2-hydroxy-2-methylpropan-1-one, 2-hydroxy-2-methyl-1-phenylpropan-1-one, 1-(4-isopropylphenyl)-2-hydroxy-2-methylpropan-1-one, and benzophenone.

Among the above, 1-hydroxy-cyclohexyl-phenyl ketone and 2-methyl-1-[4-(methylthio)phenyl]-2-morpholinopropan-1-one are preferably used in the present invention since they start or accelerate the polymerization reaction by ionizing irradiation even in small amounts.

The photoinitiator may be one of the above alone, or two or more selected from the above may be used in combination.

Examples of commercially available photoinitiators include 1-hydroxy-cyclohexyl-phenyl-ketone (product name: Irgacure 184; manufactured by: Ciba Japan).

The content of the photoinitiator is usually from about 0.1 to 20 parts by mass with respect to 100 parts by mass of the curable resin having a polymerizable group in the HC-layer composition.

### (Photosensitization Agent and Photopolymerization Accelerator)

A photosensitization agent and/or photopolymerization accelerator may be contained in the HC-layer composition, if necessary.

Examples of the photosensitization agent and photopolymerization accelerator include benzoin-based compounds such as benzoin, benzoin methyl ether, benzoin ethyl ether, benzoin isopropyl ether, α-methylbenzoin, and α-phenylbenzoin; anthraquinone-based compounds such as anthraquinone, and methylanthraquinone; benzyl; diacetyl; phenyl ketone compounds such as acetophenone, and benzophenone; sulfide compounds such as diphenyldisulfide, and tetramethylthiuram sulfide; α-chloromethyl naphthaline; anthracene; halogenated hydrocarbons such as hexachlorobutadiene, and pentachlorobutadiene; thioxanthone; n-butylamine; triethylamine; and tri-n-butylphosphine.

Among the above, a benzophenone or thioxanthone photosensitization agent is preferably used with the acetophenone-based photopolymerization initiator.

In the case of using the photosensitization agent and/or photopolymerization accelerator, the content thereof may be accordingly adjusted, for example, from 10 to 300% by mass with respect to the mass of the photoinitiator.

### (Microparticles)

In the optical film of the present invention, microparticles such as silica microparticles used for conventionally known hard coat layers may be used in order to increase the hardness of the hard coat layer. Further, reactive silica microparticles, in which the surfaces of silica microparticles have functional groups such as polymerizable groups polymerizable or crosslinkable with the functional group of the curable resin are preferable from the viewpoint of increasing the hardness of the hard coat layer.

As such reactive silica microparticles, conventionally known reactive silica microparticles may be used, for example, reactive silica microparticles disclosed in JP-A No. 2008-165040.

The average particle diameter of the microparticles is preferably 1 nm or more from the viewpoint of dispersibility. The average particle diameter of microparticles is preferably 100 nm or less from the viewpoint of securing the transparency of the hard coat layer. From the above viewpoints, the average particle diameter of microparticles is more preferably from 10 to 50 nm.

The shape of the microparticles is not particularly limited, and the examples include spherical shape and needle shape.

In the case of using the microparticles, the content thereof may be accordingly adjusted, for example, from 10 to 60% by mass with respect to the total mass (excluding solvent) of the HC-layer composition.

### (Dispersant)

In the case that the HC-layer composition contains microparticles, a conventionally known dispersant may be used to increase the dispersibility of the microparticles. As the dispersant, for example, a dispersant having an anionic polar group such as a carboxyl group, a phosphoric acid group and/or a hydroxyl group is preferable since it has good affinity with microparticles.

Examples of the dispersant having an anionic polar group include Disperbyk-110, Disperbyk-111, Disperbyk-116, Disperbyk-140, Disperbyk-161, Disperbyk-162, Disperbyk-163, Disperbyk-164, Disperbyk-170, Disperbyk-171, Disperbyk-174, Disperbyk-180 and Disperbyk-182 (product names; manufactured by BYK-Chemie Japan KK). Among the above, Disperbyk-163 has good dispersibility and preferable.

In the case of using the dispersant, the content thereof may be accordingly adjusted, for example, from 1 to 300% by mass with respect to the mass of the microparticles.

As other components of the HC-layer composition, one or more components selected from the group consisting of an anti-fouling agent, a water repellent agent, an oil repellent agent, an anti-fingerprint agent, a leveling agent, a fluidity regulator, a hardness regulator, a dazzle-proof agent, a refractive index adjusting agent and a hardness increasing agent may be used besides the above components, if necessary.

### (Other Embodiments of Optical Film)

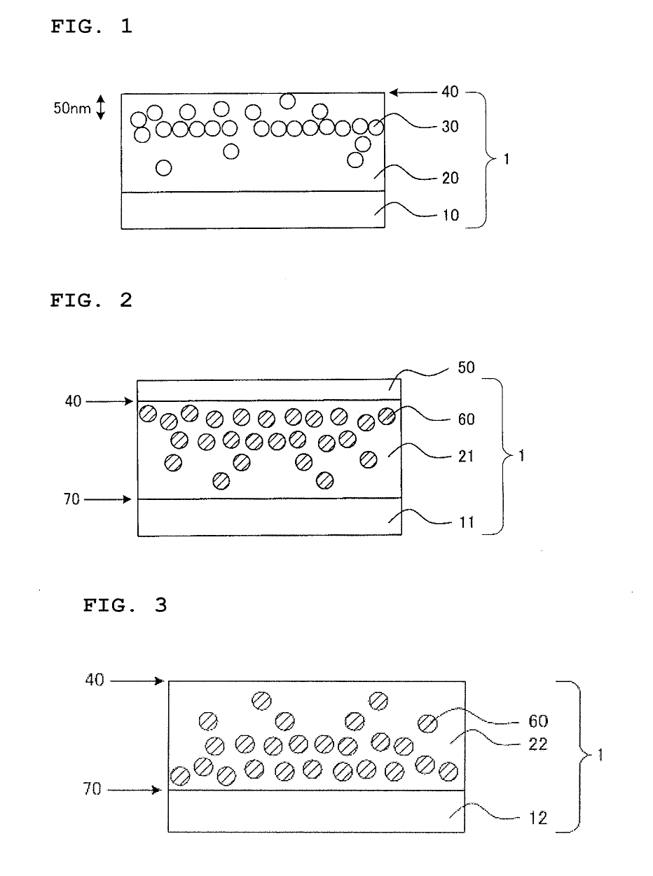

FIG. 2 is a section view schematically showing an example of a second embodiment of the optical film of the present invention.

In the optical film 1 of FIG. 2, on one side of the triacetyl cellulose substrate 11, an inclined refractive index hard coat layer 21 having a thickness of 1 to 40 μm and a low refractive index layer 50 are provided from the triacetyl cellulose substrate 11 side.

In the inclined refractive index hard coat layer 21, more amount of high refractive index microparticles 60 are present closer to the interface 40 side, and less amount of high refractive index microparticles 60 are present closer to the triacetyl cellulose substrate 11 side.

In the inclined refractive index hard coat layer of FIG. 2 and FIG. 3 hereinafter described, a good deal of the ionic liquid is present in the region from the surface of the hard coat layer to the specific depth similarly as FIG. 1, however, for the simplification of figures, the ionic liquid is omitted.

The refractive index of the inclined refractive index hard coat layer means the refractive index of the interface on the side opposite to the substrate side of the inclined refractive index hard coat layer.

Whether the refractive index of the inclined refractive index hard coat layer is inclined or not can be confirmed by the following method. The inclined refractive index hard coat layer is etched by argon sputtering to expose a portion at a particular depth of the inclined refractive index hard coat layer, and the content of high refractive index microparticles in the exposed portion is measured by means of an X ray photoelectron spectroscopy apparatus (XPS). In this way, the abundance distribution of high refractive index microparticles in the depth direction of the inclined refractive index hard coat layer can be specified. Since the refractive index of each depth point in the inclined refractive index hard coat layer correlates to the abundance of high refractive index microparticles, by confirming the fact that the abundance distribution of high refractive index microparticles in the thickness direction of the inclined refractive index hard coat layer is inclined, it is also confirmed that the refractive index is inclined.

Also, the abundance distribution of high refractive index microparticles can also be measured by embedding the optical film in a heat-curable resin, producing an ultrathin slice having a thickness of 80 nm from thus embedded optical film using Ultramicrotome (product name; manufactured by: LEICA), and observing the slice by means of a transmission electron microscope (TEM).

The high refractive index microparticle means a microparticle having a refractive index of 1.50 to 2.80.

When the absolute reflectance at the wavelength of 380 to 780 nm is measured by means of a spectrometer (product name: UV-3100PC; manufactured by: Shimadzu Corporation), the refractive index of the surface of the hard coat layer on the side opposite to the substrate side can be obtained from the obtained reflectance curve using simulation.

In the second embodiment of the optical film of the present invention, since the high refractive index microparticles 60 have the above distribution, the refractive index difference between the low refractive index layer 50 provided on the inclined refractive index hard coat layer 21 and the vicinity of the interface 40 of the inclined refractive index hard coat layer 21 becomes large, thus, high anti-reflection performance is exhibited. Further, compared to the case having the hard coat layer in which high refractive index microparticles 60 are uniformly distributed on the triacetyl cellulose substrate, the refractive index difference in the vicinity of the interface 70 between the region of the hard coat layer 21 on the triacetyl cellulose substrate 11 side and the triacetyl cellulose substrate 11 becomes small since the region wherein the high refractive index microparticles 60 having relatively high refractive index and the triacetyl cellulose substrate 11 having relatively low refractive index contact becomes small. Thereby, generation of interference fringe at the interface 70 can be inhibited.

The optical film of the second embodiment also has high antistatic performance and wipe-off resistance to solvents since it has a similar ionic liquid distribution as that of the optical film of the first embodiment.

FIG. 3 is a section view schematically showing an example of a third embodiment of the optical film of the present invention.

In the optical film 1 of FIG. 3, the inclined refractive index hard coat layer 22 having a thickness of 1 to 40 μm is provided on one side of the polyethylene terephthalate substrate 12.

In the inclined refractive index hard coat layer 22, more mount of high refractive index microparticles 60 are present closer to the interface 70 side, less amount of high refractive index microparticles 60 are present closer to the interface 40 side.

In the third embodiment of the optical film according to the present invention, since the high refractive index microparticles 60 have the above distribution, the refractive index difference in the vicinity of interface 70 between the region of the hard coat layer 22 on the polyethylene terephthalate substrate 12 side and the polyethylene terephthalate substrate 12 becomes small. Thereby, generation of interference fringe at the interface 70 can be inhibited. The reason thereof is presumed as follows. When high refractive index microparticles 60 are uniformly distributed in the hard coat layer, the percentage of the resin having a relatively low refractive index increases with respect to the polyethylene terephthalate substrate 12 having a relatively high refractive index. To the contrary, in the case of the distribution wherein more amount of high refractive index microparticles 60 are present closer to the polyethylene terephthalate substrate 12 side, the percentage of high refractive index microparticles 60 having a relatively high refractive index increases. Since the refractive index difference between the polyethylene terephthalate substrate 12 and the high refractive index microparticle 60 is smaller than that of the polyethylene terephthalate substrate 12 and the resin, the refractive index difference in the vicinity of the interface 70 between the region of the hard coat layer 22 on the polyethylene terephthalate substrate 12 side and the polyethylene terephthalate substrate 12 becomes small. Thereby, the generation of interference fringe at the interface 70 is inhibited.

Since the optical film of the third embodiment has a similar distribution of the ionic liquid as that of the optical film of the first embodiment, the optical film of the third embodiment has high antistatic performance and wipe-off resistance to solvents.

The high refractive index microparticle may be one used for conventionally known antireflection films, etc., and metal oxide microparticles can be exemplified. Examples of such metal oxide microparticles include titanium oxide (TiO₂; refractive index: 2.71), zirconium oxide (ZrO₂; refractive index: 2.10), cerium oxide (CeO₂; refractive index: 2.20), tin oxide (SnO₂; refractive index: 2.00), antimony tin oxide (ATO; refractive index: 1.75 to 1.85), indium tin oxide (ITO; refractive index: 1.95 to 2.00), phosphor tin compounds (PTO; refractive index: 1.75 to 1.85), antimony oxide (Sb₂O₅; refractive index: 2.04), aluminum zinc oxide (AZO), and gallium zinc oxide.

It is preferable to use metal oxide electrically conductive microparticles such as PTO: phosphor tin compound (for example, product name: EP SP-2; manufactured by: Mitsubishi Materials Corporation) as the high refractive index microparticles from the viewpoint of excellent transparency.

It is preferable to use metal oxide electrically conductive microparticles such as ATO: antimony tin oxide (for example, product name: SN-100P; manufactured by: Ishihara Sangyo Kaisha, Ltd.) and ITO: indium tin oxide (for example, product name: SUFP; manufactured by: Sumitomo Metal Mining Co., Ltd.) as the high refractive index microparticles from the viewpoint of imparting dust adhesion preventing properties.

Similarly as the microparticles of the first embodiment, the average particle diameter of the high refractive index microparticles is preferably from 1 to 100 nm, more preferably from 10 to 50 nm, from the viewpoint of dispersibility and transparency of the inclined refractive index hard coat layer. The shape of the high refractive index microparticles is not particularly limited, and the examples include spherical shape and needle shape.

The material, shape, and average particle diameter of the high refractive index microparticle may be accordingly selected, and the high refractive index microparticle may be one kind alone or a combination of two or more kinds.

The optical film of the second and third embodiment of the present invention can obtain such advantages that the distribution of the high refractive index microparticles in the inclined refractive index hard coat layer can be controlled, the refractive index difference at the interface between the inclined refractive index hard coat layer and the optically-transparent substrate can be decreased, and generation of interference fringe at the interface can be inhibited.

Besides the above, taking into the refractive index of the optically-transparent substrate and the refractive index of the curable resin, etc., there may be an embodiment wherein the distribution of microparticles having low refractive index is controlled such as high refractive index microparticles in FIG. 2 or FIG. 3 using microparticles having low refractive index such as silica microparticles or metal fluorides besides the high refractive index microparticle, so that the refractive index difference at the interface between the hard coat layer and the optically-transparent substrate decreases, and generation of interference fringe at the interface is inhibited.

In the present invention, the absolute value of refractive index difference between the hard coat layer and the optically-transparent substrate is preferably 0.03 or less from the viewpoint of inhibiting generation of interference fringe at the interface between the hard coat layer (besides the hard coat layer of the first embodiment, the inclined refractive index hard coat layer of the second and third embodiments are included) and the optically-transparent substrate.

The refractive index of the hard coat layer is a refractive index value obtained from the reflectance curve by simulation when the absolute reflectance at the wavelength of 380 to 780 nm is measured by means of a spectrometer (product name: UV-3100PC; manufactured by: Shimadzu Corporation).

### (Low Refractive Index Layer)

In the second embodiment of the optical film of the present invention, the low refractive index layer 50 is provided on the interface 40 of the inclined refractive index hard coat layer 21 as shown in FIG. 2.

In the inclined refractive index hard coat layer 21, more amount of high refractive index microparticles 60 are present closer to the interface 40 side, thereby, the refractive index difference between the inclined refractive index hard coat layer 21 and the low refractive index layer 50 becomes large. Hence, the optical film of the second embodiment has high anti-reflection performance.

As the low refractive index layer, conventionally known low refractive index layers may be used. The examples include a low refractive index layer containing silica microparticles, magnesium fluoride, and a fluorine-based resin disclosed in JP-A No. 2008-165040.

### (Method of Producing Optical Film)

A method of producing the optical film of the present invention may not be particularly limited if it is a method which can form a hard coat layer having the above distribution of ionic liquid in the specific depth direction from the surface of the hard coat layer.

In the present invention, from the viewpoint of easier formation of the hard coat layer having the aforementioned distribution of the ionic liquid, the following method is preferable. That is, the method of producing the optical film of the present invention comprises the steps of:

(i) preparing an optically-transparent substrate;

(ii) preparing a first curable resin composition for a hard coat layer comprising an ionic liquid containing a cation and an anion, a first curable resin and a first solvent, and a second curable resin composition for the hard coat layer comprising a second curable resin and a second solvent;

(iii) simultaneously coating at least the first curable resin composition for the hard coat layer and the second curable resin composition for the hard coat layer on one side of the optically-transparent substrate adjacently from the optically-transparent substrate side to form coating layers; and

(iv) drying and curing the coating layers obtained in the step (iii).

In the method of producing the optical film of the present invention, by simultaneously coating the first curable resin composition for the hard coat layer comprising the ionic liquid (hereinafter, it may be referred as “first HO-layer composition”) and the second curable resin composition for the hard coat layer (hereinafter, it may be referred as “second HC-layer composition”) on one side of the optically-transparent substrate adjacently from the optically-transparent substrate side, so that the first HC-layer composition is disposed closer on the optically-transparent substrate side than the second HC-layer composition, the ionic liquid is less likely to bleed out on the surface of the hard coat layer, and the hard coat layer having the aforementioned ionic liquid distribution can be easily formed. Hence, thus obtained optical film has both hardness and wipe-off resistance to solvents.

FIG. 4 is a view schematically showing an example of a method of simultaneous coating using an extrusion-type die coater.

The first HC-layer composition 100 and the second HC-layer composition 110 are simultaneously coated from slits 91 and 92 respectively of a die coater head 80 on the optically-transparent substrate 10 adjacently so that the first HC-layer composition 100 is closer to the optically-transparent substrate 10 side than the second HC-layer composition 110, to form a coating layer 101 of the first HC-layer composition and a coating layer 111 of the second HC-layer composition. In FIG. 4, the first HC-layer composition 100 and the second HC-layer composition 110 actually form one hard coat layer together, but the two kinds of compositions and the coating layers are shown in different colors for the convenience of explanation.

Hereinafter, the steps in the method of producing the optical film of the present invention using the method of simultaneous coating will be explained.

In the step (i) preparing the optically-transparent substrate, the optically-transparent substrate explained in the optical film is prepared.

In the step (ii) preparing two kinds of HC-layer compositions, each composition is prepared.

The first HC-layer composition disposed on the optically-transparent substrate side comprises the ionic liquid, the first curable resin and the first solvent. The second HC-layer composition disposed on the first HC-layer composition comprises the second curable resin and the second solvent. Each component may be one explained in the optical film.

In the method of producing the optical film of the present invention, the hard coat layer having the aforementioned ionic liquid distribution is easily formed when the viscosity of the second HC-layer composition is higher than that of the first HC-layer composition.

The method of adjusting the viscosity of the first and second HC-layer compositions is not particularly limited, but usually, the viscosity is adjusted by the content of the solvent. Besides, the viscosity may be adjusted by a kind and molecular weight of the curable resin.

The viscosity of each of the first HC-layer composition and the second HC-layer composition is measured, for example, by dropping an adequate dose of measurement object composition on a stage and measuring the viscosity by means of MCR301 (product name; manufactured by: Anton Paar) with a measurement jig of PP50, under the condition including a temperature of 25° C. and shear rate of 10,000 [l/s].

The kinds, molecular weights and numbers of functional groups of the curable resin in the first and second HC-layer compositions may be the same or different.

The kinds of solvent of the first and second HC-layer compositions may be the same or different.

If there are other components such as a photoinitiator in the first and second HC-layer compositions, the kinds of other components of the two kinds of compositions may be the same or different.

If the compositions in the first and second HC-layer compositions other than the ionic liquid are the same, a hard coat layer having no interface in the layer is likely to be obtained.

In the method of producing the optical film of the present invention, the cation in the ionic liquid contained in the first HC-layer composition is preferably one or more kinds of cations selected from the group consisting of quaternary ammonium-based cations, quaternary phosphonium-based cations, imidazolium-based cations, pyridinium-based cations and pyrrolidinium-based cations from the viewpoint of solubility and anti-static properties.

Among the above, the quaternary phosphonium-based cations are more preferable from the viewpoint of thermal stability and excellent light resistance and transparency.

In the case of forming the optical film of the second embodiment, wherein more amount of high refractive index microparticles 60 are distributed on the interface 40 side of the hard coat layer 21 as shown in FIG. 2, the simultaneous coating may be performed by not including the high refractive index microparticle 60 in the first HC-layer composition, and including the high refractive index microparticles 60 only in the second HC-layer composition. In this case, the content of the high refractive index microparticles in the second HC-layer composition is preferably from 50 to 90% by mass, more preferably from 65 to 90% by mass, with respect to the total mass (excluding solvent) of the second HC-layer composition.

On the other hand, in the case of forming the optical film of the third embodiment, wherein more amount of high refractive index microparticles 60 are distributed on the interface 70 side of the hard coat layer 22 as shown in FIG. 3, the simultaneous coating may be performed by not including the high refractive index microparticle 60 in the second HC-layer composition, and including the high refractive index microparticles 60 only in the first HC-layer composition. In this case, the content of the high refractive index microparticles in the first HC-layer composition is preferably from 50 to 90% by mass, more preferably from 65 to 90% by mass, with respect to the total mass (excluding solvent) of the first HC-layer composition.

In the step (iii) simultaneously coating the two kinds of HC-layer composition to form coating layers, the method of simultaneous coating may not be particularly limited if it is a method that can simultaneously coat the first HC-layer composition and the second HC-layer composition adjacently from the optically-transparent substrate side so that the first HC-layer composition is disposed closer to the optically-transparent substrate side than the second HC-layer composition. Examples of such a method of simultaneous coating include die coating and slide coating having two or more slits (spouts). The apparatus used for simultaneously coating may be one that two or more slits are provided to a single head, or one that two or more slits are provided to two or more head.

The coating amount of the two kinds of HC-layer compositions for simultaneous coating may be adjusted according to the desired thickness of the hard coat layer, distribution of ionic liquid, etc. For example, the first HC-layer composition may be coated at the wet layer thickness of about 0.05 to 100 μm (equivalent in layer thickness after drying: 0.05 to 20 μm). The second HC-layer composition may be coated, for example, at the wet layer thickness of about 0.05 to 100 μm (equivalent in layer thickness after drying: 0.05 to 20 μm). Herein, the wet layer thickness means a thickness of the coating layer just after coating and before the solvent in the composition volatilizes, and can be calculated from “(volume of composition coated on the optically-transparent substrate/coated area)”.

### (Polarizing Plate)

The polarizing plate of the present invention is provided with a polarizer on the optically-transparent substrate side of the optical film.

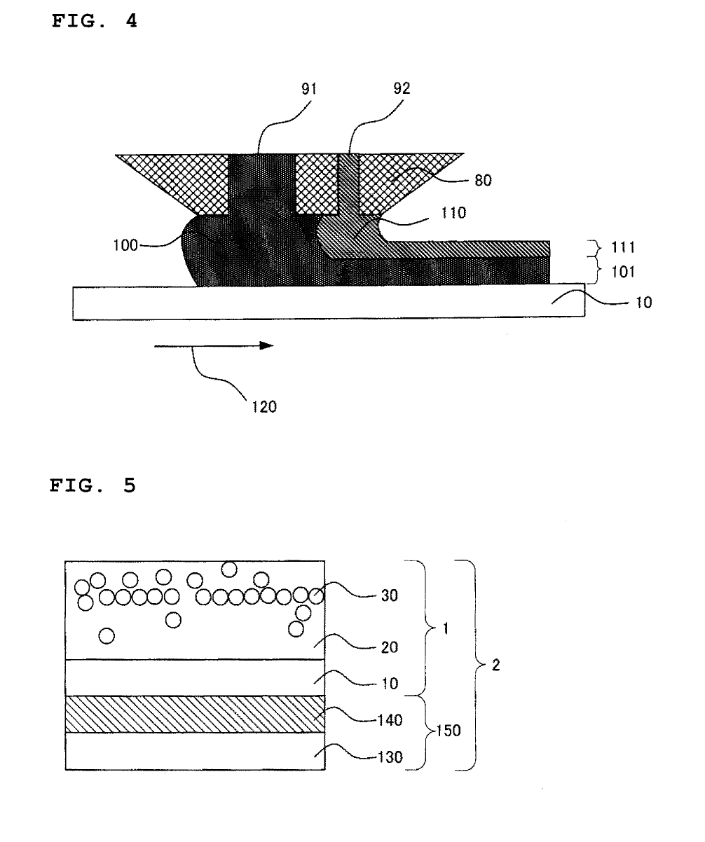

FIG. 5 is a view schematically showing an example of a layer structure of the polarizing plate of the present invention. The polarizing plate 2 shown in FIG. 5 has the optical film 1 having the hard coat layer 20 containing the ionic liquid 30 on the optically-transparent substrate 10, and the polarizer 150 having a protecting film 130 and a polarizing layer 140 laminated, and the polarizer 150 is provided on the optically-transparent substrate 10 side of the optical film 1.

“The polarizer is disposed on one side of the optically-transparent substrate side of the optical film” includes the case wherein the optical film and the polarizer are separately formed, but also the case wherein a member constitutes both optical film and polarizer.

As the optical film, the aforementioned optical film can be used, thus, the explanation is omitted herein. Hereinafter, other components of the polarizing plate of the present invention will be explained.

### (Polarizer)

The polarizer used for the polarizing plate of the present invention may not be limited if it has predetermined polarization properties, and polarizers generally used for liquid crystal displays may be used.

The polarizer may not be limited if it is in a form that predetermined polarization properties can be retained for long periods, for example, it may be constituted with a polarizing layer alone, or may be a laminate of a protecting film and a polarizing layer. When the protecting film and the polarizing layer are laminated, the protecting film may be only formed on one side of the polarizing layer, or protecting films may be formed on both sides of the polarizing layer.

As the polarizing layer, generally, one obtained by impregnating a film made of polyvinyl alcohol with iodine, and performing uniaxial orientation with the film to form a complex of the polyvinyl alcohol and the iodine, may be used.

The protecting film is not particularly limited if it can protect the polarizing layer, and has a desired optical transparency.

As for the optical transparency of the protecting film, the transmittance in the visible light region is preferably 80% or more, more preferably 90% or more.

The transmittance of the protecting film can be measured as defined in JIS K7361-1 (Plastics—Determination of the total luminous transmittance of transparent materials).

Examples of the resin constituting the protecting film include cellulose derivatives, cycloolefin-based resins, polymethyl methacrylate, polyvinyl alcohols, polyimides, polyarylates, and polyethylene terephthalate. Among the above, it is preferable to use a cellulose derivative or a cycloolefin-based resin.

### (Display Panel)

A first display panel of the present invention is provided with the aforementioned optical film.

A second display panel of the present invention is provided with the aforementioned polarizing plate.

A display panel is generally a member disposed on the viewer side of a display. Taking a liquid crystal display as an example, a display panel is a member comprising two glass plates (e.g. a color filter substrate and an array substrate) having liquid crystal material sealed, a polarizing plate, the optical film of the present invention, etc.

Hence, the display panel of the present invention is provided with the aforementioned optical film or polarizing plate as a member on the viewer side of the display.

### (Display)

The first display of the present invention is provided with the aforementioned optical film.

The second display of the present invention is provided with the aforementioned display panel.

Examples of the display include LCD, PDP, ELD (organic EL, inorganic EL), and CRT.

The display comprises the display panel as a member on the viewer side of the display and a back-side member including a drive unit. Taking a liquid crystal display as an example, the back-side member is a member comprising a light source called as a backlight, a driver circuit controlling an LCD, a circuit controlling the light source and chassis. An example of the layer structure of such a liquid crystal display includes one comprising a backlight part including a light guide plate, diffusion film, etc., and on the viewer side thereof, a polarizing plate, an array substrate, a liquid crystal layer, a color filter substrate, a polarizing plate, and an optical film layered in this order.

Another example of the display, PDP, comprises a front-side glass substrate, and a back-side glass substrate disposed to face the front-side glass substrate with discharge gas sealed therebetween. In the case that the display is PDP, the aforementioned optical film may be provided to the surface of the front-side glass substrate or the front-face plate (glass substrate or film substrate).

The display may be any of displays including an ELD device, in which an illuminant which emits light when voltage is applied such as zinc sulfide, and diamines substances is deposited on a glass substrate, and the voltage applied to the substrate is controlled to display, a CRT, in which an electrical signal is converted to light to generate visible image for humans, etc. In this case, the aforementioned optical film may be provided on the topmost of ELD device or CRT or the surface of its front-face plate.

### Example

Hereinafter, with reference to Examples, the present invention will be explained in more detail, but the present invention may not be limited thereby.

The abbreviations of compounds represent the following:

DPHA: dipentaerythritol hexaacrylate

MIBK: methyl isobutyl ketone

TAC: triacetyl cellulose

First HC-layer composition 1, Second HC-layer composition 1, and Second HC-layer composition 2 having the following compositions were respectively prepared.

### (First HC-Layer Composition 1)

Ionic liquid (tributyl(2-methoxyethyl)phosphonium bis(trifluoromethanesulfonyl)imide; manufactured by: Tokyo Kasei Kogyo Co., Ltd.): 5 parts by mass

First curable resin (DPHA; manufactured by: NIPPON KAYAKU CO., LTD.): 50 parts by mass

First curable resin (product name: BEAMSET DK1; manufactured by: Arakawa Chemical Industries, Ltd.; weight average molecular weight: 20,000; solid content: 75%; MIBK solvent): 50 parts by mass (solid content equivalent)

Leveling agent (product name: MCF-350; manufactured by: DIC CORPORATION): 3 parts by mass (solid content equivalent)

Photoinitiator (product name: Irgacure 184; manufactured by: Ciba Japan): 4 parts by mass

Solvent (MIBK): 100 parts by mass

### (Second HC-Layer Composition 1)

Second curable resin (DPI-IA; manufactured by: NIPPON KAYAKU CO., LTD.): 50 parts by mass

Second curable resin (product name: BEAMSET DK1; manufactured by: Arakawa Chemical Industries, Ltd.; weight average molecular weight: 20,000; solid content: 75%; MIBK solvent): 50 parts by mass (solid content equivalent)

Leveling agent (product name: MCF-350; manufactured by: DIC CORPORATION): 3 parts by mass (solid content equivalent)

Photoinitiator (product name: Irgacure 184; manufactured by: Ciba Japan): 4 parts by mass

Solvent (MIBK): 100 parts by mass

### (Second HC-Layer Composition 2)

Second curable resin (product name: BEAMSET DK1; manufactured by: Arakawa Chemical Industries, Ltd.; weight average molecular weight: 20,000; solid content: 75%; MIBK solvent): 100 parts by mass (solid content equivalent)

Leveling agent (product name: MCF-350; manufactured by: DIC CORPORATION): 3 parts by mass (solid content equivalent)

Photoinitiator (product name: Irgacure 184; manufactured by: Ciba Japan): 4 parts by mass

### Example 1

First HC-layer composition 1 at the wet layer thickness of 15 μm (equivalent in layer thickness after drying: about 8 μm) and Second HC-layer composition 1 at the wet layer thickness of 1 μm (equivalent in layer thickness after drying: about 0.5 μm) were simultaneously coated on a TAC substrate having a thickness of 40 μm so that First HC-layer composition 1 was disposed closer on the TAC substrate side than Second HC-layer composition 1. After removing a solvent by drying in an oven, ultraviolet irradiation was performed at the irradiance level of about 95 mJ/cm² by means of an ultraviolet irradiation device (manufactured by: Fusion UV Systems Japan KK; light source: H bulb) to cure coating layers. Thus, a hard coat layer having a layer thickness after drying of about 8 μm was formed. Then, an optical film having a structure of TAC substrate/hard coat layer was produced.

### Example 2

Except that the wet layer thickness of Second HC-layer composition 1 was 0.5 μm (equivalent in layer thickness after drying: about 0.3 μm) in the simultaneous coating, a hard coat layer having a layer thickness after drying of about 8 μm was formed and then an optical film was produced similarly as Example 1.

### Example 3

A hard coat layer was formed by sequential coating as follows.

After First HC-layer composition 1 was applied at the wet layer thickness of 15 μm (equivalent in layer thickness after drying: about 8 μm) on a TAC substrate having a thickness of 40 μm and dried in an oven to remove a solvent, ultraviolet irradiation was performed at the irradiance level of about 36 mJ/cm² by means of an ultraviolet irradiation device (manufactured by: Fusion UV Systems Japan KK; light source: H bulb) to cure a coating layer. Thus, a hard coat layer of the lower-layer side was formed.

Next, Second HC-layer composition 2 was applied at the wet layer thickness of 2 μm (equivalent in layer thickness after drying: about 1 μm) on the hard coat layer of the lower-layer side. After removing a solvent by drying in an oven, ultraviolet irradiation was performed at the irradiance level of about 95 mJ/cm² by means of an ultraviolet irradiation device to cure coating layers. Thus, a hard coat layer having a layer thickness after drying of upper and lower layers in total of about 9 μm was formed. Then, an optical film having a structure of TAC substrate/hard coat layer was produced.

### Comparative Example 1

Except that Second HC-layer composition 1 was used instead of Second HC-layer composition 2, Second HC-layer composition 1 was applied at the wet layer thickness of 1 μm (equivalent in layer thickness after drying: about 0.5 μm) on a hard coat layer of the lower-layer side, and a hard coat layer having a layer thickness of upper and lower layers in total of about 8 μm was formed, an optical film was produced similarly as in Example 3.

### Comparative example 2

Except that Second HC-layer composition 1 was applied at the wet layer thickness of 0.5 μm (equivalent in layer thickness after drying: about 0.3 μm) on the hard coat layer of the lower-layer side, and a hard coat layer having a layer thickness of upper and lower layers in total is about 8 μm was formed, an optical film was produced similarly as in Comparative example 1.

### Comparative Example 3

First HC-layer composition 1 was applied at the wet layer thickness of 15 μm (equivalent in layer thickness after drying: about 8 μm) on a TAC substrate having a thickness of 40 μm. After removing a solvent by drying in an oven, ultraviolet irradiation was performed at the irradiance level of about 95 mJ/cm² by means of an ultraviolet irradiation device (manufactured by: Fusion UV Systems Japan KK; light source: H bulb) to cure a coating layer. Thus, a hard coat layer having a layer thickness after drying of about 8 μm was formed. Then, an optical film having a structure of TAC substrate/hard coat layer was produced.

The wet layer thickness and coating method of each composition in Examples and Comparative examples are shown in Table 1.

TABLE 1

| | | | Second HC-layer | | |
|---|---|---|---|---|---|
| | | | composition | | |
| | First HC-layer | | (upper-layer side) | | |
| | composition | | | Wet | |
| | (lower-layer side) | | | layer | |
| | | Wet layer | | thick- | |
| | Type | thickness | Type | ness | Coating |
| | (Number) | (μm) | (Number) | (μm) | method |
| Example 1 | 1 | 15 | 1 | 1 | Simultaneous |
| | | | | | coating |
| Example 2 | 1 | 15 | 1 | 0.5 | Simultaneous |
| | | | | | coating |
| Example 3 | 1 | 15 | 2 | 2 | Sequential |
| | | | | | coating |
| Comparative | 1 | 15 | 1 | 1 | Sequential |
| example 1 | | | | | coating |
| Comparative | 1 | 15 | 1 | 0.5 | Sequential |
| example 2 | | | | | coating |

| | | | | |
|---|---|---|---|---|
| Comparative | 1 | 15 | None | One-time |
| example 3 | | | | coating of |
| | | | | single layer |

The following distribution of ionic liquid, surface resistance value, hardness, haze, total light transmittance and adhesion of each of optical films produced in Examples and Comparative examples were measured and evaluated.

### (Measurement of Ionic Liquid Distribution)

The distribution of ionic liquid was obtained by measuring the concentration of sulfur atoms contained in the ionic liquid (tributyl(2-methoxyethyl)phosphonium.bis(trifluoromethanesulfonyl)imide) from the surface of the hard coat layer (interface 40) to the layer thickness (depth) direction by means of an XPS device (product name: ESCA-3400; manufactured by: KRATOS).

Firstly, the optical film was cut so as to cover a sample board, and the optical film was attached on the sample board via a pressure-sensitive adhesive sheet. Thus, an analytical sample was formed.

In the XPS measurement, the surface of the hard coat layer of the optical film was etched by ion sputtering (Ar⁺ was irradiated using an ion gun for sputtering (high speed ion gun; Kaufman type ion gun)) to expose a part having a specific depth from the surface of the hard coat layer, and the depth of the exposed part was gradually increased.

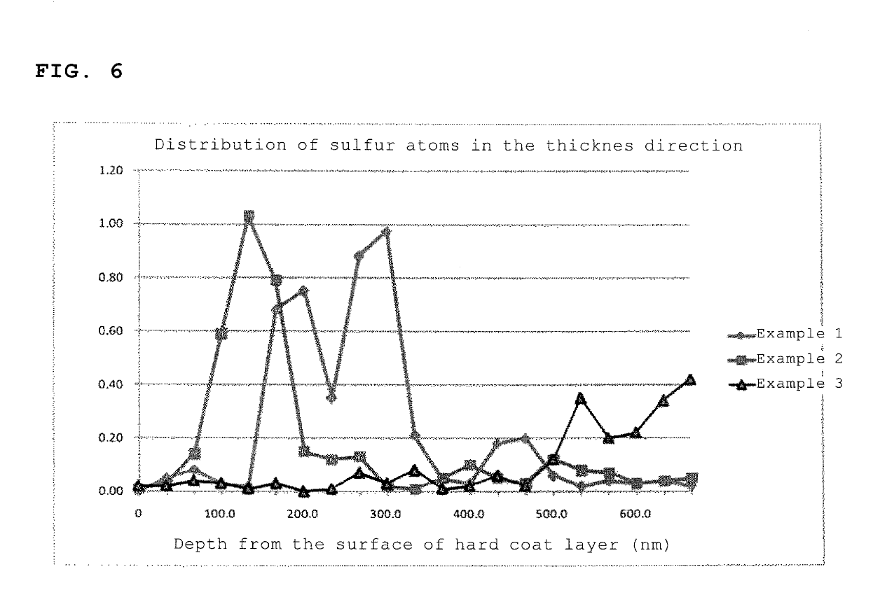

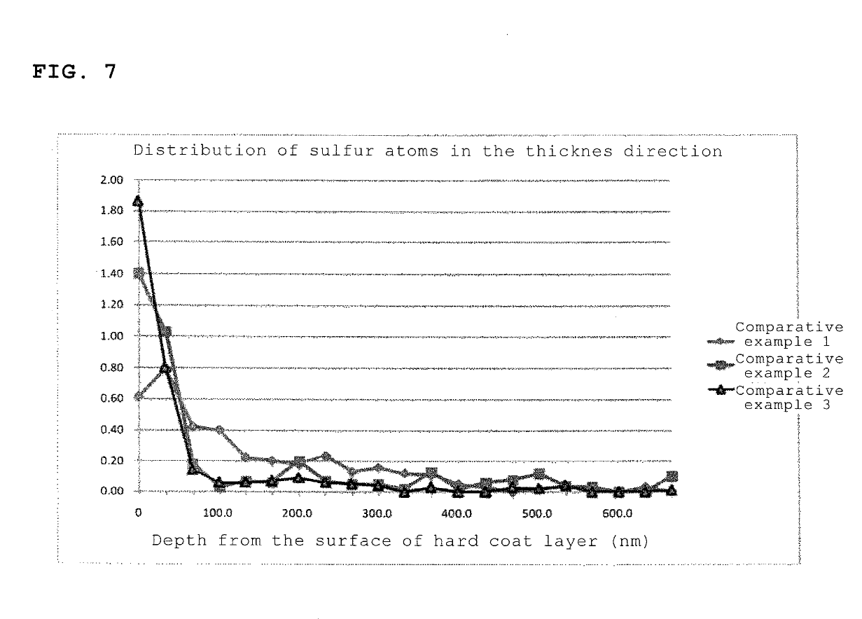

The measurement results of each optical film produced in the above Examples and Comparative examples are shown in Table 2. The measurement results of the optical films of Examples are shown as a graph in FIG. 6, and those of the optical films of Comparative examples are shown as a graph in FIG. 7, respectively.

TABLE 2

| Depth from the | S (Sulfur) concentration (%) | | | | | |
|---|---|---|---|---|---|---|
| surface of HC | | | | Comparative | Comparative | Comparative |
| layer (nm) | Example 1 | Example 2 | Example 3 | example 1 | example 2 | example 3 |
| 0 | 0.00 | 0.01 | 0.02 | 0.61 | 1.40 | 1.86 |
| 33.3 | 0.05 | 0.03 | 0.02 | 0.79 | 1.03 | 0.80 |
| 66.6 | 0.08 | 0.14 | 0.04 | 0.42 | 0.18 | 0.14 |
| 100.0 | 0.03 | 0.59 | 0.03 | 0.40 | 0.03 | 0.06 |
| 133.3 | 0.02 | 1.03 | 0.01 | 0.22 | 0.07 | 0.06 |
| 166.7 | 0.68 | 0.79 | 0.03 | 0.20 | 0.06 | 0.07 |
| 200.0 | 0.75 | 0.15 | 0.00 | 0.18 | 0.20 | 0.09 |
| 233.3 | 0.35 | 0.12 | 0.01 | 0.23 | 0.07 | 0.06 |
| 266.7 | 0.88 | 0.13 | 0.07 | 0.13 | 0.05 | 0.05 |
| 300.0 | 0.97 | 0.02 | 0.03 | 0.16 | 0.05 | 0.04 |
| 333.3 | 0.21 | 0.01 | 0.08 | 0.12 | 0.02 | 0.00 |
| 366.7 | 0.05 | 0.05 | 0.01 | 0.11 | 0.13 | 0.03 |
| 400.0 | 0.03 | 0.10 | 0.02 | 0.05 | 0.02 | 0.00 |
| 433.3 | 0.18 | 0.05 | 0.06 | 0.03 | 0.06 | 0.00 |
| 466.7 | 0.20 | 0.03 | 0.02 | 0.00 | 0.08 | 0.03 |
| 500.0 | 0.06 | 0.12 | 0.12 | 0.02 | 0.12 | 0.02 |
| 533.3 | 0.02 | 0.08 | 0.35 | 0.04 | 0.04 | 0.04 |
| 566.7 | 0.04 | 0.07 | 0.20 | 0.01 | 0.03 | 0.00 |
| 600.0 | 0.03 | 0.03 | 0.22 | 0.00 | 0.00 | 0.00 |
| 633.3 | 0.04 | 0.04 | 0.34 | 0.03 | 0.00 | 0.00 |
| 666.7 | 0.02 | 0.05 | 0.42 | 0.00 | 0.10 | 0.01 |
| Total S1 | 4.69 | 3.64 | 2.10 | 3.75 | 3.74 | 3.36 |
| abundance from | | | | | | |
| interface (%) | | | | | | |
| Total S2 | 0.05 | 0.04 | 0.04 | 1.40 | 2.43 | 2.66 |
| abundance from | | | | | | |
| interface to 50 nm | | | | | | |
| (%) | | | | | | |
| Ratio of S2 with | 1.1 | 1.1 | 1.9 | 37.3 | 65.0 | 79.2 |
| respect to S1 (%) | | | | | | |

### (Evaluation of Wipe-Off Resistance to Solvents)

The wipe-off resistance to solvents of each of the optical films produced in Examples and Comparative examples is evaluated as follows.

Firstly, the surface resistance value of the surface of the hard coat layer in the initial state before wiping off with a solvent was measured by means of Hiresta (product name; manufactured by: Mitsubishi Chemical Corporation; measurement limit: 1.00×10¹³Ω).

Next, the same part of the surface of the hard coat layer was wiped for ten times using a waste (product name: Bemcot lint-free; manufactured by: Asahi Kasei Corporation) impregnated with water, and then wiped with a dried waste for ten times. The same was performed using a waste impregnated with ethanol and a waste impregnated with MIBK. The water, ethanol and MIBK were the same in quantity. Thereafter, the surface resistance value was measured similarly as the above. The measurement results are shown in Table 3.

### (Measurement of Pencil Hardness)

Pencil hardness test (Load: 4.9 N) defined in JIS K5600-5-4 (1999) was performed on the surface of the hard coat layer of each of the optical films produced in Examples and Comparative examples, and the highest hardness without scratch was measured. The measurement results are shown in Table 3.

### (Measurement of Haze and Total Light Transmittance)

The haze and total light transmittance of each of the optical films produced in Examples and Comparative examples were measured by means of turbidimeter (product name: NDH2000; manufactured by: Nippon Denshoku Industries Co., Ltd.). Measurement results are shown in Table 3.

### (Evaluation of Adhesion)

Each of the optical films produced in Examples and Comparative examples was subjected to the adhesion test by the cross-cut test as defined in JIS K5600-5-6 using an industrial 24 mm tape (registered trademark: Sellotape; manufactured by: Nichiban Co., Ltd.) as an adhesion tape to evaluate the adhesion. The measurement results are shown in Table 3.

TABLE 3

| | Wipe-off resistance to solvent | | | | | | | |
|---|---|---|---|---|---|---|---|---|
| | Surface resistance value (Ω/□)*¹ | | | | | | | |
| | | After | After | After | | | Total light | |
| | | wiping off | wiping off | wiping off | Pencil | Haze | transmittance | |
| | Initial state | with water | with ethanol | with MIBK | hardness | (%) | (%) | Adhesion*² |
| Example 1 | 2.61 × 10¹⁰ | 3.59 × 10¹⁰ | 3.24 × 10¹⁰ | 2.48 × 10¹⁰ | 2H | 0.22 | 93.20 | 100/100 |
| Example 2 | 1.94 × 10¹⁰ | 3.03 × 10¹⁰ | 2.35 × 10¹⁰ | 2.48 × 10¹⁰ | 2H | 0.20 | 92.45 | 100/100 |
| Example 3 | 1.41 × 10¹⁰ | 7.93 × 10¹⁰ | 3.84 × 10¹¹ | 5.36 × 10¹¹ | 2H | 0.20 | 92.20 | 35/100 |
| Comparative | 3.53 × 10¹⁰ | 6.02 × 10¹² | over | over | 2H | 0.22 | 93.20 | 42/100 |
| example 1 | | | | | | | | |
| Comparative | 6.92 × 10¹⁰ | over | over | over | 2H | 0.20 | 92.45 | 60/100 |
| example 2 | | | | | | | | |
| Comparative | 8.27 × 10⁹ | over | over | over | 2H | 0.23 | 93.08 | 100/100 |
| example 3 | | | | | | | | |

*¹“over” represents it is over the measurement limit (1.00 × 10¹³ Ω/□).
*²Adhesion is represented by “(number of unpeeled grids)/(total number of grids)”.

### (Summary of Results)

As it can be understood from Table 2 and FIG. 6, while there is a peak of concentration of sulfur atoms at the depth of 300 nm from the surface (interface 40) of the hard coat layer in Example 1, there is a peak of concentration of sulfur atoms at the depth of 33.3 nm in Comparative example 1. The half bandwidth of peak in Example 1 was 83 nm.

Similarly, while there is a peak of concentration of sulfur atoms at the depth of 133.3 nm in Example 2, there is a peak of concentration of sulfur atoms at the depth of 0 nm in Comparative example 2. The half bandwidth of peak in Example 2 was 90 nm.

Similarly, while there is a peak of concentration of sulfur atoms at the depth of 666.7 nm in Example 3, there is a peak of concentration of sulfur atoms at the depth of 0 nm in Comparative example 3. The half bandwidth of peak in Example 3 was 60 nm.

From the above, it can be understood that there is the peak of abundance of the ionic liquid at a deeper location than 50 nm from the interface 40 of the hard coat layer in the optical film of the present invention.

The optical films obtained in Examples as shown in Table 3, has a similar surface resistance value as the initial state even after wiping off with the solvent. Particularly, the wipe-off resistance to the organic solvents including ethanol and MIBK is excellent.

However, in the optical film obtained in Comparative example 1, the surface resistance value after wiping off with water shows double-digit increase. Further, it does not have wipe-off resistance to the organic solvents.

The optical films obtained in Comparative examples 2 and 3 did not have wipe-off resistance to all of water, ethanol and MIBK.

### INDUSTRIAL APPLICABILITY

The optical film of the present invention is usable as it is for products requiring anti-static properties. In an embodiment of the optical film of the present invention, the optical film capable of exhibiting both anti-static properties and hard coating performance can be provided. In more preferable embodiment, the optical film having anti-static properties and hard coating performance, capable of lowering reflection, and having no interference fringe can be provided. Hence, it is usable for building materials having dust adhesion preventing properties (decorative sheet, etc.), overcoats to be provided on the surface of optical disks, etc.

### REFERENCE SIGNS LIST

1: Optical film
2: Polarizing plate
10: Optically-transparent substrate
11: Triacetyl cellulose substrate
12: Polyethylene terephthalate substrate
20: Hard coat layer
21, 22: Inclined refractive index hard coat layer
30: Ionic liquid
40: Interface
50: Low refractive index layer
60: High refractive index microparticle
70: Interface
80: Die head
91, 92: Slit
100: First curable resin composition for hard coat layer
101: Coating layer of first curable resin composition for hard coat layer
110: Second curable resin composition for hard coat layer
111: Coating layer of second curable resin composition for hard coat layer
120: conveying direction of optically-transparent substrate
130: Protecting film
140: Polarizing layer
150: Polarizer
160: Substrate
170: Conventional hard coat layer
180: Ionic liquid
190: Cover layer

1. An optical film comprising an optically-transparent substrate, and a hard coat layer having a thickness of 1 to 40 μm on one side of the optically-transparent substrate, wherein
the hard coat layer comprises an ionic liquid containing a cation and an anion, and
a region between a depth of 50 nm and a depth of 700 nm from an interface of the hard coat layer on a side opposite to an optically-transparent substrate side has a peak of an abundance of the ionic liquid present in an area from the interface to the depth of 700 nm in a thickness direction of the hard coat layer.

2. The optical film according to claim 1, wherein a half bandwidth of the peak is from 25 to 500 nm.

3. The optical film according to claim 1, wherein a percentage of the abundance of the ionic liquid present in a region between the interface and the depth of 50 nm therefrom is 50% or less with respect to the abundance of the ionic liquid present in the area from the interface to the depth of 700 nm.

4. The optical film according to claim 1, wherein the cation is one or more kinds of cations selected from the group consisting of quaternary ammonium-based cations, quaternary phosphonium-based cations, imidazolium-based cations, pyridinium-based cations and pyrrolidinium-based cations.

5. The optical film according to claim 1, wherein the surface resistance value of the hard coat layer is 1.0×10¹³Ω/□ or less.

6. The optical film according to claim 1, wherein a low refractive index layer is provided on the side opposite to the optically-transparent substrate side of the hard coat layer.

7. A method of producing an optical film comprising the steps of:
(i) preparing an optically-transparent substrate;
(ii) preparing a first curable resin composition for a hard coat layer comprising an ionic liquid containing a cation and an anion, a first curable resin and a first solvent, and a second curable resin composition for the hard coat layer comprising a second curable resin and a second solvent;
(iii) simultaneously coating at least the first curable resin composition for the hard coat layer and the second curable resin composition for the hard coat layer on one side of the optically-transparent substrate adjacently from an optically-transparent substrate side to form coating layers; and
(iv) drying and curing the coating layers obtained in the step (iii).

8. The method of an optical film according to claim 7, wherein the cation is one or more kinds of cations selected from the group consisting of quaternary ammonium-based cations, quaternary phosphonium-based cations, imidazolium-based cations, pyridinium-based cations and pyrrolidinium-based cations.

9. A polarizing plate comprising the optical film defined by any one of claims 1 to 6 and a polarizing element provided on the optically-transparent substrate side of the optical film.

10. A display panel provided with the optical film defined by any one of claims 1 to 6.

11. A display panel provided with the polarizing plate defined by claim 9.

12. A display provided with the optical film defined by any one of claims 1 to 6.

13. A display provided with the display panel defined by claim 11.

14. A display provided with the display panel defined by claim 10.
